(19) United States
(12) Patent Application Publication
(10) Pub. No.: US 2020/0167652 A1
(43) Pub. Date: May 28, 2020

(54) IMPLEMENTATION OF INCREMENTAL AI MODEL FOR EDGE SYSTEM

(71) Applicant: General Electric Company, Schenectady, NY (US)

(72) Inventors: Dayu HUANG, Niskayuna, NY (US); Colin PARRIS, Brookfield, CT (US); Xiao BIAN, Niskayuna, NY (US); Huan TAN, Clifton Park, NY (US); Kiersten RALSTON, Niskayuna, NY (US); Shaopeng LIU, Clifton Park, NY (US); Guiju SONG, Niskayuna, NY (US)

(21) Appl. No.: 16/199,877

(22) Filed: Nov. 26, 2018

(51) Int. Cl. G06N 3/08; G06N 5/04; G06N 20/20; G06N 3/04

(52) U.S. Cl. CPC G06N 3/082; G06N 3/0427; G06N 20/20; G06N 5/043

(57) ABSTRACT

The example embodiments are directed to a system and method for cold start deployment of an ML model for an edge system associated with an industrial asset. In one example, the method may include one or more of storing an incremental ML model comprising a plurality increments which sequentially increase a complexity of a predictive function of the incremental ML model, receiving performance information from an edge system that processes incoming data of an industrial asset using a current increment of the incremental ML model, dynamically determining to modify the current increment of the incremental ML model used by the edge system with a next increment of the incremental ML model having increased complexity based on the received performance information, and transmitting the next increment of the incremental ML model to the edge system.

### BACKGROUND

Machine and equipment assets are engineered to perform particular tasks as part of a process. For example, assets can include, among other things, industrial manufacturing equipment on a production line, drilling equipment for use in mining operations, wind turbines that generate electricity on a wind farm, transportation vehicles (trains, subways, airplanes, etc.), gas and oil refining equipment, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the overwhelming adoption of cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

An industrial internet of things (IIoT) network incorporates machine learning and big data technologies to harness the sensor data, machine-to-machine (M2M) communication and automation technologies that have existed in industrial settings for years. The driving philosophy behind IIoT is that smart machines are better than humans at accurately and consistently capturing and communicating real-time data. This data enables companies to pick up on inefficiencies and problems sooner, saving time and money and supporting business intelligence (BI) efforts. IIoT holds great potential for quality control, sustainable and green practices, supply chain traceability and overall supply chain efficiency.

In an IIoT, edge devices sense or otherwise capture data and submit the data to a cloud platform or other central host. Data provided from edge devices may be used in a large variety of industrial applications. In a cloud-edge system, artificial intelligence (AI) models having machine learning capabilities are maintained in the cloud and operated based on key information that is collected from different edge devices. When an edge device is added to the IIoT network, the edge device may be configured with one or more AI models. Typically, the edge device is pre-configured with a specific AI model based on a type of industrial asset that the edge device will be collecting data from.

However, edge environments are often different and dynamic. For example, an edge device may receive data from one sensor or many sensors. Also, operation of sensors may deteriorate over time. As another example, an edge device may be added when an industrial asset is just starting up versus when the industrial asset has been operating for a significant period of time. Different factors contribute to changes in AI model performance. These factors can prevent an initially deployed AI device from working properly or being of value to the network. Therefore, a mechanism is needed which can improve initial deployment of an AI model on a edge device.

### SUMMARY

According to an aspect of an example embodiment, a computing system may include one or more of a storage configured to store machine learning (ML) models and local edge information where the ML models are already deployed, a network interface configured to receive, via a network, meta information of an edge system associated with an industrial asset in response to a cold start of the edge system, and a processor configured to dynamically determine an optimum ML model for the cold start of the edge system from among the already deployed ML models based on the received meta information and the local edge information, and the processor may be further configured to control the network interface to transmit the determined optimum ML model to the edge system.

According to an aspect of another example embodiment, a method may include one or more of storing machine learning (ML) models and local edge information where the ML models are already deployed, receiving, via a network, meta information of an edge system associated with an industrial asset in response to a cold start of the edge system, dynamically determining an optimum ML model for the cold start of the edge system from among the already deployed ML models based on the received meta information and the local edge information, and transmitting the determined optimum ML model to the edge system.

According to an aspect of another example embodiment, a method may include one or more of storing a machine learning (ML) model and local configuration information of a source edge system where the ML model is already deployed, receiving, via a network, a request for an ML model from a receiving edge system associated with an industrial asset in response to a cold start of the receiving edge system, cloning parameters of the ML model and the local configuration of the source edge system where the ML model is deployed to generate a cloned ML model configuration, and transmitting the cloned ML model configuration to the receiving edge system.

According to an aspect of another example embodiment, a computing system may include one or more of a storage configured to store an incremental ML model that includes a plurality increments which sequentially increase a complexity of a predictive function of the incremental ML model, a processor configured to receive performance information from an edge system processing incoming data of an industrial asset using a current increment of the incremental ML model, and dynamically determine to modify the current increment of the incremental ML model used by the edge system with a next increment of the incremental ML model having increased complexity based on the received performance information, and a network interface configured to transmit the next increment of the incremental ML model to the edge system.

According to an aspect of another example embodiment, a method may include one or more of storing an incremental ML model comprising a plurality increments which sequentially increase a complexity of a predictive function of the incremental ML model, receiving performance information from an edge system processing incoming data of an industrial asset using a current increment of the incremental ML model, dynamically determining to modify the current increment of the incremental ML model used by the edge system with a next increment of the incremental ML model having increased complexity based on the received performance information, and transmitting the next increment of the incremental ML model to the edge system.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing system for industrial software and hardware in accordance with an example embodiment.

FIG. 2 is a diagram illustrating a system of edge devices having different meta information in accordance with an example embodiment.

FIG. 3 is a diagram illustrating a process of performing an initial model search for cold start deployment in accordance with example embodiments.

FIG. 4 is a diagram illustrating a configuration of an AI model being cloned among edge devices in accordance with example embodiment.

FIG. 5A is a diagram illustrating a process of updating an incremental ML model in accordance with an example embodiment.

FIG. 5B is a diagram illustrating a graph showing model complexity with respect to each ML model increment in FIG. 5A, in accordance with an example embodiment.

FIG. 6A is a diagram illustrating a method for performing an initial model search for cold start deployment in accordance with an example embodiment.

FIG. 6B is a diagram illustrating a method for cloning a local model configuration in accordance with an example embodiment.

FIG. 6C is a diagram illustrating a method of incrementing an incremental ML model in accordance with an example embodiment.

FIG. 7 is a diagram illustrating a computing system configured for use within any of the example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

In a cloud-edge environment within an industrial network such as an Industrial Internet of Things (IIoT), edge devices collect data from an industrial machine and/or equipment referred to as industrial assets. For example, edge devices may receive time-series data associated with an operation of the asset sensed by sensors that are connected to or disposed around the asset. As another example, edge devices may receive images of the asset which can be used to analyze and detect deterioration or damage to the asset. Often, edge devices have one or more machine learning (ML) models, also referred to as artificial intelligence (AI) models executing therein which help to identify and predict information about an asset such as operating characteristics, the need for maintenance and repair, if a control setting needs to be changed, if a part needs to be replaced, and the like.

Traditionally, an ML model comes pre-configured on an edge device such as an industrial PC, asset control system, edge computer, on-premises server, user device, or the like. The pre-configured ML model is typically based on the type of industrial asset that the edge device will be receiving data of/from. However, edge conditions are not always the same. For example, edge devices have a number of dynamic properties such as sensor availability, geographical location and location with respect to the asset, time at which the edge device is operating, type of industrial asset, and the like. The dynamic properties can cause the initially pre-configured ML model to perform poorly or in a manner that is not beneficial to the overall system.

The example embodiments overcome the drawbacks of the prior art by dynamically providing an ML model at cold start of an edge system. For example, a cloud platform may initially deploy a dynamically chosen ML model on an edge system based on meta information of a hardware environment and other factors at the edge system where the ML model is being deployed. The example embodiments also provide an incrementally configurable ML model than can be dynamically incremented over time to create more complexity (and more accuracy) based on model performance. The first increment may be the cold start deployed model, but this is not a requirement. Some of the benefits of the system described herein include dynamic deployment of ML models to an edge system which results in faster and better quality deployment of ML models on edge systems with respect to traditional methods. Furthermore, the system achieves better end-to-end performance of an ML model over its lifetime by making it incrementally configurable through different increments.

According to various embodiments, a cloud platform may automatically select an optimum ML model for cold start deployment to an edge device based on a dynamic operating environment information associated with the edge device. The operating environment information may include available sensor information (including any sensors not working properly), location of the sensors/edge system with respect to the industrial asset, a time at which the model is being deployed, a type of the edge system, and the like. Typically, edge devices are pre-configured with AI models based on a type of asset that the edge device is to be collecting data from. The pre-configuration, however, does not account for the operating environment where the model will be operating. The example embodiments enable a more efficient and better quality starting ML model on the edge device because it considers dynamic environment information about the edge device where the ML model will be deployed. This type of information cannot be addressed by pre-configured ML models because this information is dynamic at the time of deployment. The cold start process can use this information to provide the edge device with a most appropriate model.

According to various embodiments, an incremental ML model is provided. In some embodiments, a cloud platform may provide automated incremental updates of an already deployed AI model on an edge device based on model performance. In this example, the ML model may have additional layers/configurations that can be incremented over time beginning with an initial deployment where the model is in its least complexity (basic) to later stages where the model becomes more sophisticated. Initially, an ML model may have sporadic data points. In this case, a more sophisticated model would not perform well because there is not enough data to work with. As a result, the model performance would suffer. However, the edge system may be provided with a basic model that works better (more accurate) with less data points.

In some embodiments, the accuracy of the basic (1^{st} increment) ML model may have a lower accuracy saturation point than a more sophisticated increment of the ML model. For example, the simple ML model may have an accuracy saturation point of 60% accuracy while the most sophisticated ML model may have an accuracy saturation point at 90% accuracy. Therefore, as the basic ML model improves its performance, it can be upgraded in increments to a next level to create even better accuracy. The increments may include adding a new layer to the neural network, etc. As the increments are configured, the incrementally-configurable ML model performance gradually increases to its maximum accuracy capabilities as more data is received.

Edge devices may use machine learning models to monitor and predict attributes associated with the industrial asset. Often, an ML model is processed on edge data that is collected from sensors on or about the industrial asset. For example, sensors may capture time-series data (temperature, pressure, vibration, etc.) about an industrial asset which can be processed using ML models to identify operating characteristics of the industrial asset that need to be changed. As another example, images may be captured of an industrial asset which can be processed using ML models to identify various image features or regions of interest (e.g., damage, wear, tear, etc.) to the industrial asset. In order for these models to operate accurately, the models must be configured appropriately.

In the example of image data, the image data may be used to detect a specific feature from an industrial asset (e.g., damage to a surface of the asset, etc.) A machine learning model may be trained to identify how likely such a feature exists in an image. A result of the ML model output may be a data point for the image where the data point is arranged in a multi-dimensional feature space with a likelihood of the feature existing within the image being arranged on one axis (e.g., y axis) and time on another axis (e.g., x axis). As another example, time-series data may be used to monitor how a machine or equipment is operating over time. Time-series data may include temperature, pressure, speed, etc. Here, the ML model may be trained to identify how likely it is that the operation of the asset is normal or abnormal based on the incoming-time series data.

In some cases, data captured from the industrial asset may be received in raw form and converted into feature space by an ML model. The data may be processed in clusters or segments. Each data point in a cluster may represent an image captured by a camera or a reading sensed by a sensor. The edge system may convert the raw data into data points within the feature space using an ML model. The resulting data points may be graphed as a pattern of data that can be compared with a pattern of data of a previous data clusters. In the examples herein, the common ML model component may be generally used by all edge devices when processing incoming data, while edge-specific ML model components may be used by only the respective edge device where they are stored.

The system and method described herein may be implemented via a program or other software that may be used in conjunction with applications for managing machine and equipment assets hosted within an industrial internet of things (IIoT). An IIoT may connect assets, such as turbines, jet engines, locomotives, elevators, healthcare devices, mining equipment, oil and gas refineries, and the like, to the Internet or cloud, or to each other in some meaningful way such as through one or more networks. The cloud can be used to receive, relay, transmit, store, analyze, or otherwise process information for or about assets and manufacturing sites. In an example, a cloud computing system includes at least one processor circuit, at least one database, and a plurality of users and/or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

Assets may be outfitted with one or more sensors (e.g., physical sensors, virtual sensors, etc.) configured to monitor respective operations or conditions of the asset and the environment in which the asset operates. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

The edge-cloud system may be used in conjunction with applications and systems for managing machine and equipment assets and can be hosted within an IIoT. For example, an IIoT may connect physical assets, such as turbines, jet engines, locomotives, healthcare devices, and the like, software assets, processes, actors, and the like, to the Internet or cloud, or to each other in some meaningful way such as through one or more networks. The system described herein can be implemented within a “cloud” or remote or distributed computing resource. The cloud can be used to receive, relay, transmit, store, analyze, or otherwise process information for or about assets. In an example, a cloud computing system includes at least one processor circuit, at least one database, and a plurality of users and assets that are in data communication with the cloud computing system. The cloud computing system can further include or can be coupled with one or more other processor circuits or modules configured to perform a specific task, such as to perform tasks related to asset maintenance, analytics, data storage, security, or some other function.

While progress with industrial and machine automation has been made over the last several decades, and assets have become ‘smarter,’ the intelligence of any individual asset pales in comparison to intelligence that can be gained when multiple smart devices are connected together, for example, in the cloud. Aggregating data collected from or about multiple assets can enable users to improve business processes, for example by improving effectiveness of asset maintenance or improving operational performance if appropriate industrial-specific data collection and modeling technology is developed and applied.

The integration of machine and equipment assets with the remote computing resources to enable the IIoT often presents technical challenges separate and distinct from the specific industry and from computer networks, generally. To address these problems and other problems resulting from the intersection of certain industrial fields and the IIoT, the example embodiments provide a mechanism for triggering an update to a ML model upon detection that the incoming data is no longer represented by the data pattern within the training data which was used to initially train the ML model.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial or healthcare based assets can be uniquely situated to leverage its understanding of assets themselves, models of such assets, and industrial operations or applications of such assets, to create new value for industrial customers through asset insights.

As described in various examples herein, data may include a raw collection of related values of an asset or a process/operation including the asset, for example, in the form of a stream (in motion) or in a data storage system (at rest). Individual data values may include descriptive metadata as to a source of the data and an order in which the data was received, but may not be explicitly correlated. Information may refer to a related collection of data which is imputed to represent meaningful facts about an identified subject. As a non-limiting example, information may be a dataset such as a dataset which has been determined to represent temperature fluctuations of a machine part over time.

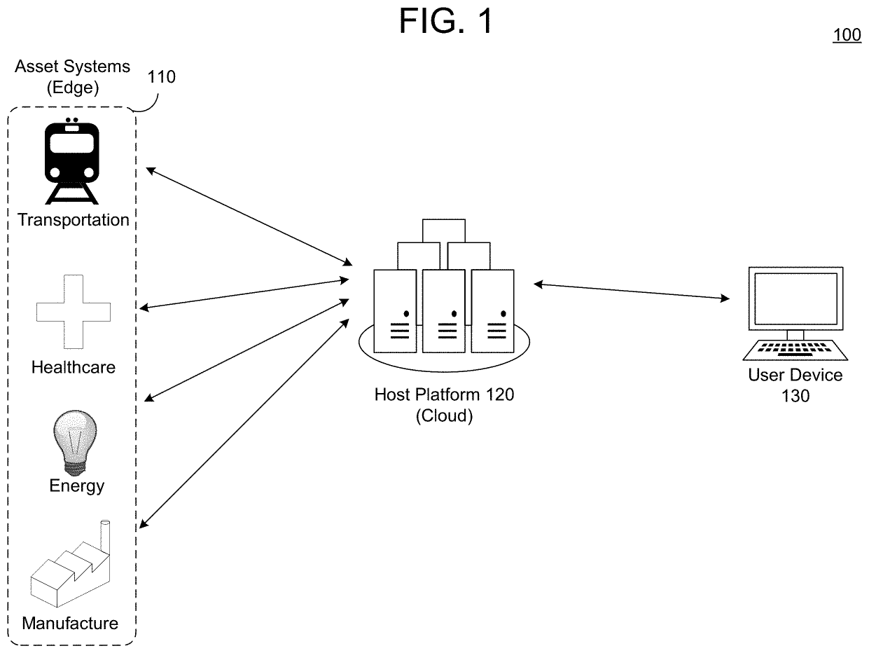

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like. A digital replica (i.e., a digital twin) of an asset 110 may be generated and stored on the cloud platform 120. The digital twin may be used to virtually represent an operating characteristic of the asset 110.

The data transmitted by the assets 110 and received by the cloud platform 120 may include raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets), may be hosted by the cloud platform 120, and may interact with the assets 110. For example, ML models (or AI models) may be used to optimize a performance of an asset or data coming in from the asset. As another example, the ML models may be used to predict, analyze, control, manage, or otherwise interact with the asset and components (software and hardware) thereof. The ML models may also be stored in the cloud platform 120 and/or at the edge (e.g. asset computing systems, edge PC's, asset controllers, etc.)

A user device 130 may receive views of data or other information about the asset as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function, process, operation, etc., of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

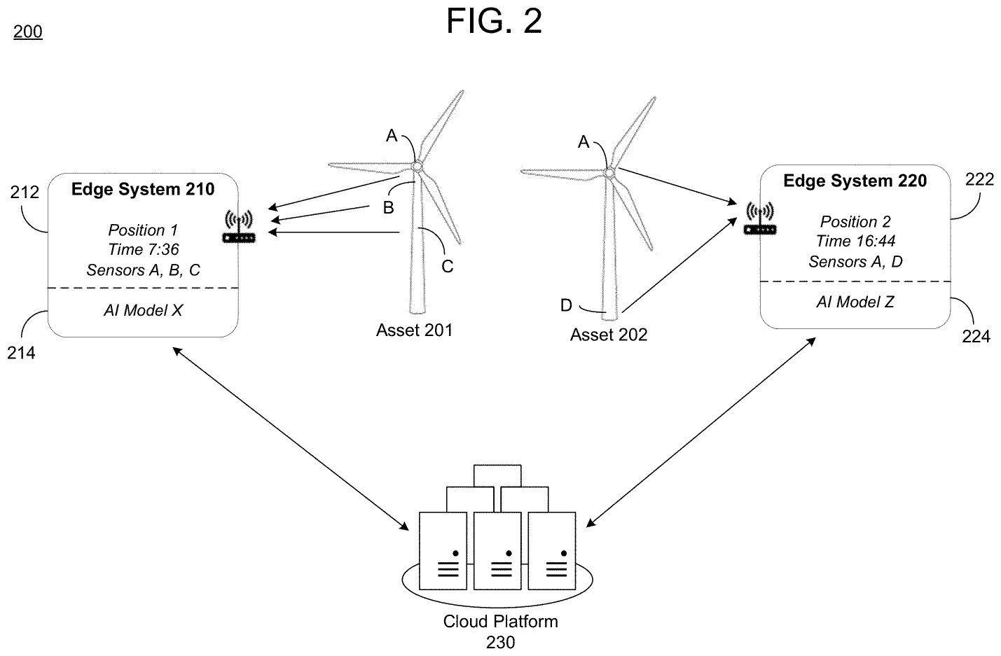

FIG. 2 illustrates a system 200 which includes edge systems 210 and 220 which have different meta information in accordance with an example embodiment. Referring to the example of FIG. 2, the edge systems 210 and 220 may be edge computers (PCs), intervening edge servers, asset controllers, user devices, on-premises servers, and the like. Here, the edge systems 210 and 220 may collect data from assets 201 and 202, respectively, and feed the collected data back to a cloud platform 230. Prior to sending the data to the cloud platform 230, the edge systems 210 and 220 may process the raw data from the assets 201 and 202 using a machine learning model, or multiple machine learning models.

In the example of FIG. 2, each of the assets 201 and 202 correspond to a same type of industrial asset which in this case is a wind turbine. However, embodiments are not limited to turbines and may include any other type of industrial machine, equipment, etc., such as locomotives, healthcare equipment, X-ray machines, gas turbines, elevators, or the like, which perform industrial actions. Not all edge devices are disposed in the same types of physical environments or at the same time.

According to various embodiments, meta information about the edge systems 210 and 220 may be stored by the respective edge systems and provided to the cloud platform 230 during a cold start of the edge systems 210 and 220. In the example of FIG. 2, edge system 210 may have meta information 212 which includes geographical location (position 1), time of deployment (7:36), sensor types, number of sensors (3), positions (A, B, C) of the sensors with respect to the industrial asset 201, and the like. Meanwhile, the edge system 220 may have different respective meta information 222 which includes geographical location (position 2), time of deployment (16:44), sensor types, number of sensors (2), positions (A, D) of the sensors with respect to the industrial asset 202, and the like.

When the edge systems 210 and 220 are started up (cold start), the edge systems 210 and 220 may broadcast or otherwise transmit their respective meta information 212 and 222 to the cloud platform 230. In response, the cloud platform 230 may determine an optimal machine learning model for each of the edge systems 210 and 220 based on the provided meta information 212 and 222. In the example of FIG. 2, the cloud platform provides model 214 to edge system 210 and model 224 to edge system 220 which are different models having different parameters, based on the meta information provided.

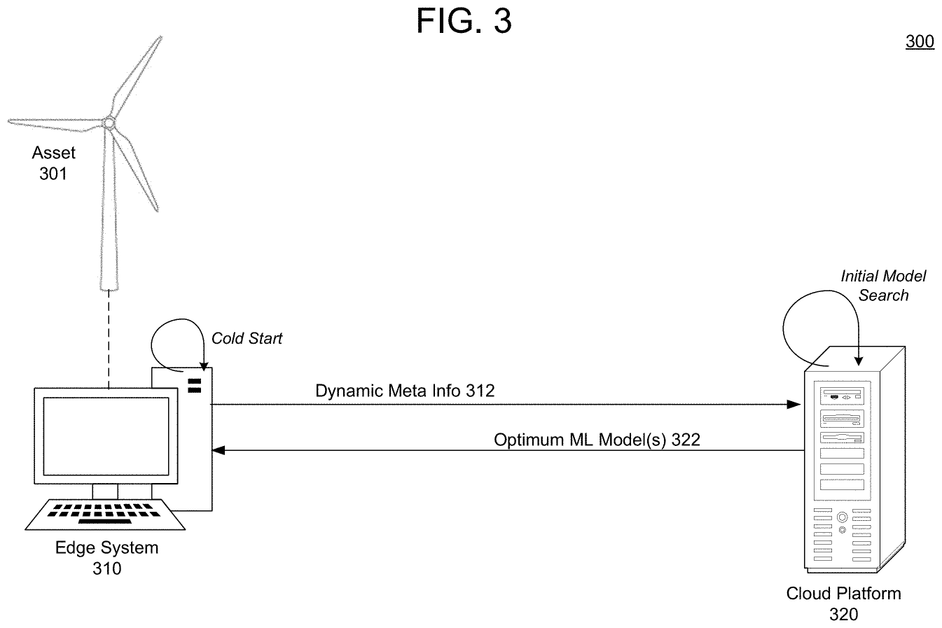

An example of edge systems providing meta information to the cloud platform at cold start of the edge system is shown in FIG. 3. Referring to FIG. 3, a system 300 includes an edge system 310 that is configured to receive data from an asset 301. During an initial powering-on of the edge system 310, the edge system 310 may transmit dynamic meta information 312 associated with the edge system 310 to a cloud platform 320. The meta information may include the attributes shown in meta information 212 and 222 shown in FIG. 2, however, embodiments are not limited thereto. In this example, the edge system 310 may be configured with a set of computer instructions such that when the edge system is first started or otherwise deployed to work with the industrial asset 310, the meta information 312 is transmitted to the cloud platform 320. The goal is to transfer necessary information from cloud platform 320 (and other edge AI systems not shown) to the first-time deployed edge system 310.

According to various embodiments, the cloud platform 320 may store local edge information of other edge systems (not shown) which include ML models that are already deployed thereon and working appropriately. The local edge information may include the same type of information as the meta information 312. For example, the other edge devices may have already provided ML models, algorithms, software packages, and associated hyperparameters to the cloud platform 320.

When a connection is available between the edge system 310 and the cloud platform 320, the edge system 310 may transmit the meta information 312. In response, the cloud platform 320 may compare the meta information 312 of the edge system 310 with stored local edge information of other edge devices having already deployed ML models. For example, the newly deployed edge system 310 may compile the set of meta information 312 such as edge system type, info of the assets/sensing devices that the edge system 310 is connected to, location and time of deployment, etc.

In response, the cloud platform 320 may compare the meta information 312 of this new edge system 310 with other edge systems that have been already deployed to find the closest match of ML model(s) with respect to the problems the new edge system 310 is solving. If the cloud is unavailable, the new edge system 310 can broadcast within the local edge network, and the other edge systems may compare and find the match instead of the cloud platform 320. In this alternative example, the matched ML model(s) may be sent directly or fused and sent to the new edge system 310 to be deployed. A fused model could be a model with parameters that are “average” of parameters from other models on the other edge systems. Also, the ML models already deployed may be determined as working satisfactorily reducing the need for calibration and testing at the new edge system 310.

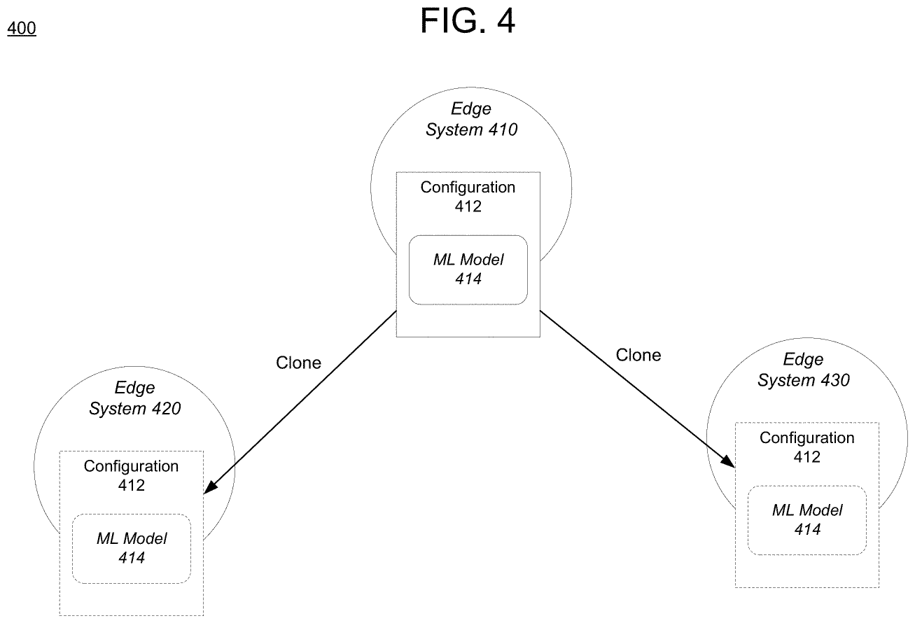

The example embodiments provide a mechanism of how to setup initial parameters or configuration of an AI model on a newly deployed (cold start) edge system. An initial model search performed by the cloud platform or other system is dependent on the environment (sensors available, time, location, etc.) of the edge system which can be different at the time of deployment. This is not preconfigurable because it is dependent at the time of deployment. Therefore, the initial model search can identify and deploy a dynamic AI model than can have a changed configuration depending on the deployment environment. FIG. 4 illustrates an established configuration 412 associated with an AI model 414 being cloned among edge systems in accordance with example embodiment. Referring to FIG. 4, an edge environment 400 includes a cluster of edge systems 410, 420, and 430 which may receiving incoming sensed from or otherwise captured of an industrial asset or industrial assets. In some examples, the edge systems 410-430 may each be associated with the same type of industrial asset or different types of industrial assets. The edge systems 410-430 may communicate directly with one another via an ad-hoc network, or other type of wired or wireless network. That is, the edge systems 410-430 may communicate without having to indirectly communicate through a cloud platform.

In this example, an edge system may configured by an ML model configuration deployed on a neighboring edge system. The edge system 410 may be deployed prior to either of edge systems 420 and 430. In this case, the edge system 410 may subsequently clone and broadcast its ML model 414 and configuration data 412 to the other edge systems 420 and 430 thereby quickly configuring the other edge systems 420 and 430 with the same ML model and configuration information such as model parameters (weights, coefficients, neural network layers, etc.).

For example, after the first edge system 410 is deployed, an option is provided to the user to set this first edge device as a broadcast source. The option could be a button to press on the edge system 410, a GUI or command line that is input via a display of the first edge system 410, or the like. Once selected, the edge system 410 may be to broadcast its configuration data 412 including its ML model 414. The broadcast may be performed physically via local wireless communications, or virtually over a communication networks. When deploying the other edge systems 420 and 430, different strategies may be provided. For example, a user may be provided with an option to use the broadcasted configurations by either clicking a button, a GUI, or a command line. In response, the edge system 410 may be automatically configured as a broadcast source for configuring newly added edge systems 420 and 430 when they are deployed from cold start. To identify the broadcast source, the edge systems 420 and 430 may use time and geographical location as well as device information to associate with the broadcast source (edge system 410).

As will be understood, after a setup of a first edge system, a user may select an option to clone all the setup procedures for the next edge device which creates a one-click edge system deployment. There is a first deployment process in which the first edge system is configured for use with an AI model. The next edge system can have an AI setup/configuration that is a clone of the first edge system. In other words, the second edge system may have a replicate of the configuration of the first edge system. It is essentially a one-click cloning deployment of an AI model. This can be useful when an operator has multiple edge systems (e.g., 5, 10, 25, 100, etc.) to deploy and configure.

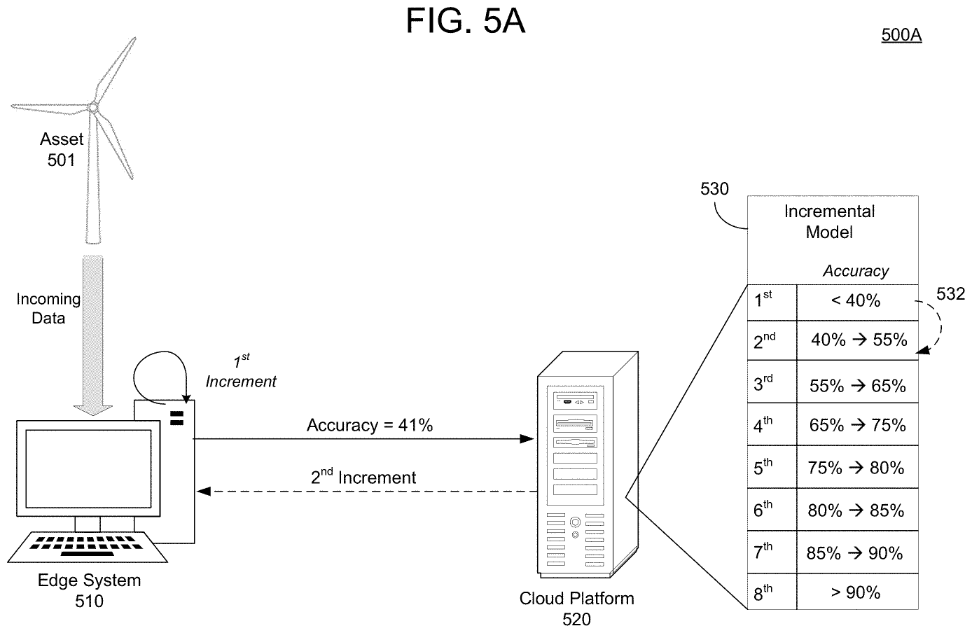

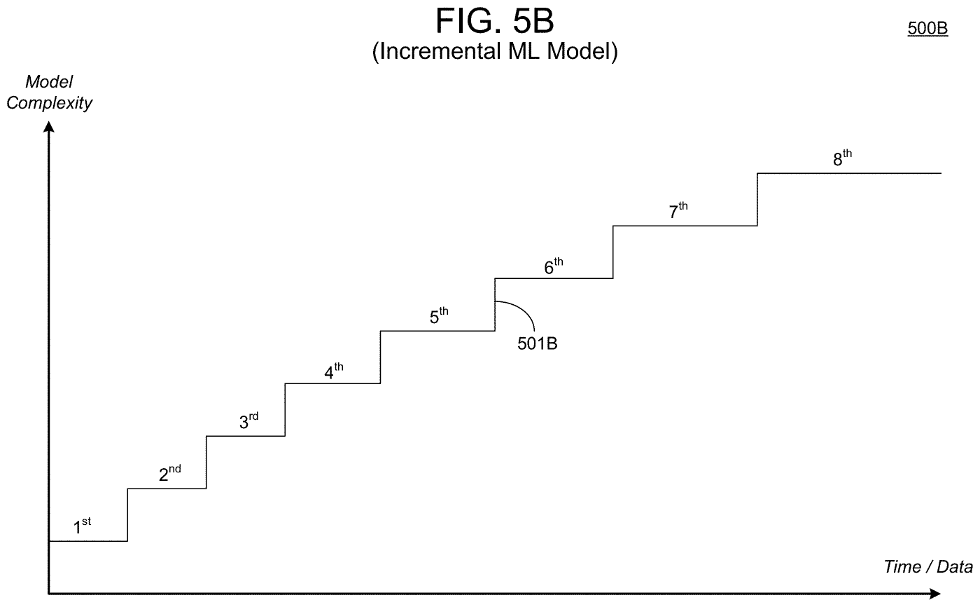

FIG. 5A illustrates a process 500A of updating an incremental ML model in accordance with an example embodiment, and FIG. 5B illustrates a graph 500B showing model complexity with respect to each ML model increment in FIG. 5A, in accordance with an example embodiment. Referring to FIG. 5A, an edge system 510 receiving incoming data from an asset 501. For example, the incoming data may be image data, video data, time series data, and the like. In response, the edge system 510 executes a ML model on the incoming data to identify features of interest within the data. For image data, the feature may be a region of the asset 501 where damage is shown. For time-series data, the feature may be an operating characteristic of the asset indicating maintenance, a replacement part, a change in settings, or the like, is needed. In this example, the edge system 510 executes an incrementally configurable ML model 530 which can be provided from a central system such as cloud platform 520.

According to various embodiments, model complexity of the ML model 530 deployed on the edge system 510 may be configured to increase in complexity with time or amount of data that is being processed by the edge system 510. To enable this, the ML model 530 is designed to have multiple versions (i.e., increments) each with different complexity, which could be measured as the number of parameters. At deployment, the model may have a relatively small complexity when deployed to the edge system 510.

During the period following the edge device deployment, the cloud platform 520 may gradually increase the complexity of the model 530 via incremental model update. In the example of FIG. 5A, the model 530 has eight (8) increments. A first increment may be provided to the edge system 510 during deployment or cold start of the edge system 510. Meanwhile, a next increment of the model 530 can be used to replace the current increment when the current increment achieves an accuracy threshold. However, the embodiments are not limited to accuracy being the driving force behind the increments. As another example, the increments may be performed when the incoming data achieves a threshold, a period of time has reached a threshold, a number of activated sensors providing data changes, and the like. Accordingly, the cloud platform 520 may sequentially provide increments of the ML model 530 to the edge system 510 in incremental steps based on one or more factors such as accuracy, amount of data, time, and the like.

In the example of FIG. 5A, the edge system 510 is currently executing the first increment of the ML model 530 and updates are performed based on performance information that includes the accuracy of the model, however, embodiments are not limited to accuracy being the metric that is used. In this example, the edge system 510 has achieved an accuracy of 41% with the first increment. This information is provided to the cloud platform 520 which compares the accuracy to a threshold limit (<40%) for the first increment. In this case, the cloud platform 520 determines (as shown by reference 532) that the edge system 510 has achieved an accuracy threshold for the first increment and that it is time to upgrade the ML model 530 on the edge system 510 to include the second increment of the ML model which has more complexity. For example, the second increment may include an additional layer to a neural network, an additional parameter of the ML algorithm, an additional weight, or the like.

Accuracy may be determined in various ways. For example, upon receiving data points from devices (e.g., sensors, cameras, etc.) connected to the edge system, a set of “fitting” metrics may be computed for the ML model (i.e., AI model) on the edge system. These metrices evaluate the applicability of the ML model on the recently collected data. A few examples of metrics that may be used to calculate accuracy including a percentage of data points outside an input range of the ML model, a distance in feature space (where raw data is mapped based on the ML model) between new data points and those used in the training of the ML model, a distance between an output of the ML model on this device and other devices that include a deployment of the same ML model, cross-validation error, and the like. In some cases, it is possible to use a plurality of the metrics to determine an accuracy of the current increment of the ML model. Based on the value of the metrics, the deployment software may change the AI models or system configuration by removing an AI model from the edge system, replacing the AI model with another version, triggering an update to AI model parameters, resetting a connection to devices sending data, logging an alert, and the like.

It should also be appreciated that accuracy is just one type of metric that can be used to update the incremental ML model. As another example, an amount of data, an amount of time, noise level in sensor data, range of recent input data, availability of sensors, and the like. Also, as further explained below, it is possible to use a different type of incremental model, and not a sequentially linear model.

FIG. 5B illustrates a graph 500B showing the changes in complexity of the model as the increments are performed as indicated by the complexity line 501B. The increments create additional complexity as accuracy improves, time goes by, data points increase, more sensors are activated, or the like.

Initially, the cloud platform 520 may deploy a basic/simple model because the edge system may not have a lot of information yet. The model may not be very accurate this way. After a period of time from the initial deployment, the device may start to automatically change the model based on various attributes (time, sensors activated, amount of data points coming to the system, performance or accuracy of the model, etc.). For example, if the accuracy performance starts to increase, the cloud may switch to the next more complex model. Then you perform incremental model update based on meta information (time, sensors activated, data points, performance, etc.) to trigger changes in the model itself. Not just triggering data changing but triggering a change in the function of the model itself.

To enable changing models, different metrics may be used to check the model performance. For example, metrics could rely on the amount of data points that are being captured and processed by the AI model. To change the model the platform may pull and replace, or can update a current model. The idea is to use meta information to incrementally and automatically change the model configuration. Each increment could be more functional parameters or adding a parameter layer. Essentially the AI model has different configurations that can be incremented over time from cold deployment where the model is in its least complexity to later stages where the model becomes more sophisticated. The benefits here is that if you only have a few data points (initially) a more sophisticated model would not perform well because there is not enough data to work with therefore model performance would suffer.

However, if you start with a simple model, the model would work better with less data points. The accuracy of the simple model may saturate at 60%, etc. As more data points come in, the accuracy of the simple model may go up, and then you could switch to a more complex model as performance goes up. The other benefit is that you don't know everything when you deploy a system (e.g., 2 sensors, 3 sensors, etc.) But there may be issues with certain physical pieces. Such as one sensor may not work properly. This creates a performance issue. The incremental model adjustment may address this issue as well. Usually, the models are linearly incremental. But there may be certain situations where the model is not getting more improvement at some point and the middle-step increments may be the best performing model.

In the example of FIG. 5B, a sequential linear growth model is provided, however embodiments are not limited thereto. As another example, a possible variation is a “tree” like structure in which the metrics are not used in a sequentially linear way. For example, a change in performance may cause the model to be reverted to a previous increment. As another example, the change in performance may cause the current increment of the model to skip ahead multiple increments, decrements, to a next version of the model, or the like, based on nodes on the tree structure. As another example, the model update may not be linear at all. For example, a list of models may be provided in the form of a list, and the updated may be provided based on a search of the list to find a best model having a complexity that matches for the current performance information. As another example, different models may be used at different stages of the increments. For example, the amount of data coming in may cause a new model to be chosen given the amount of input data has changed. In this case, complexity may go up or down. As another example, different metrics may be used at different stages of the increments.

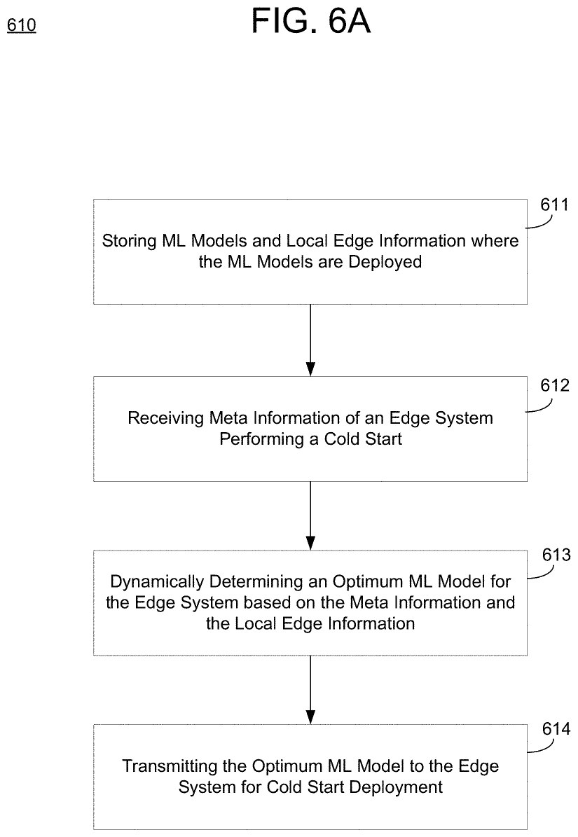

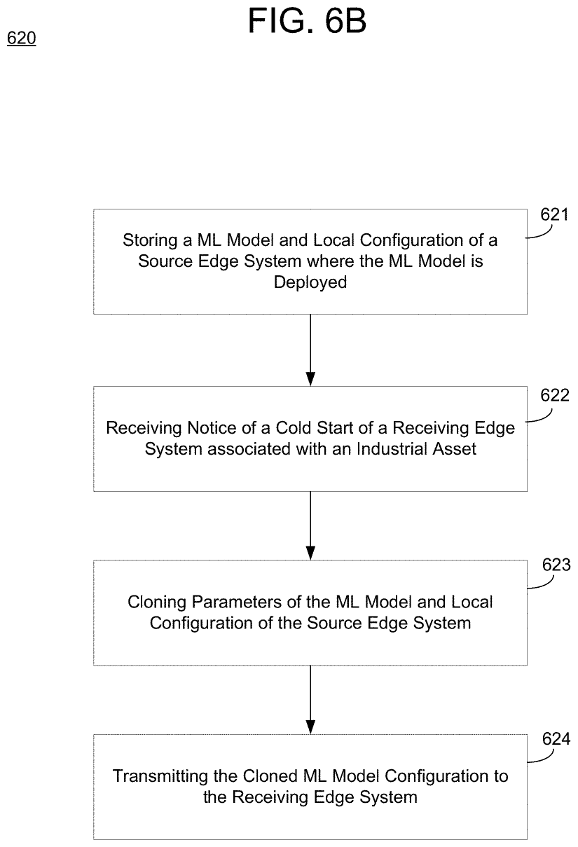

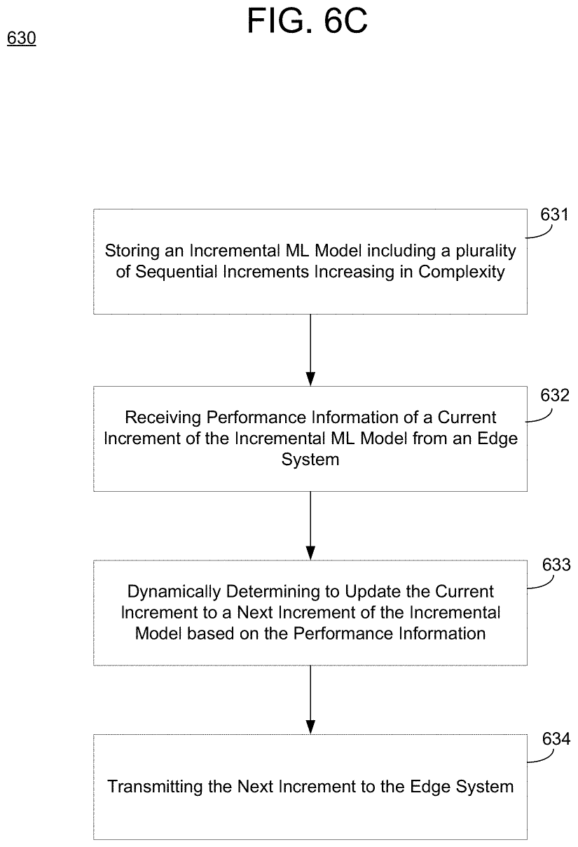

FIG. 6A illustrates a method 610 for performing an initial model search for cold start deployment in accordance with an example embodiment. For example, the method 610 may be performed by a computing system such as a cloud platform, a neighboring edge system, a web server, a database, a user device, and the like. Referring to FIG. 6A, in 611, the method may include storing machine learning (ML) models and local edge information where the ML models are already deployed. For example, the stored local edge information of an ML model may include one or more of a geographic location of an edge device where the ML model is deployed, a time at which the ML model was deployed, and sensor information associated with the edge device where the ML model is deployed. The sensor information may include a number of sensors sending data to the edge system, an availability of the sensors, a location of the sensors with respect to the asset, and the like.

In 612, the method may include receiving, via a network, meta information of an edge system associated with an industrial asset in response to a cold start of the edge system. In some embodiments, the received meta information of the edge system may include one or more of a geographic location of the edge system, a timing at which the ML model is going to be deployed on the edge system, and sensor information associated with the edge system. In some embodiments, the received meta information of the edge system comprises a task to be performed by the edge system.

In 613, the method may include dynamically determining an optimum ML model for the cold start of the edge system from among the already deployed ML models based on the received meta information and the local edge information, and in 614, the method may include transmitting the determined optimum ML model to the edge system. In some embodiments, the determining may include performing an initial model search for the optimum ML by comparing the received meta information with local edge information of a plurality of ML models already deployed. For example, the determined ML model may include initial parameter values for the ML model for processing incoming data of the industrial asset. As another example, the determined optimum ML model may be configured to detect regions of interest of the industrial asset based on image data captured of the industrial asset. In some embodiments, the determined optimum ML model may be configured to identify changes in an operating characteristic of the industrial asset based on time-series data sensed from an operation of the industrial asset.

FIG. 6B illustrates a method 620 for cloning a local model configuration in accordance with an example embodiment. For example, the method 620 may be performed by a source edge system such as a user device, a server, a database, an edge PC, an on-premises server, and the like. Referring to FIG. 6B, in 621, the method may include storing a machine learning (ML) model and local configuration information of a source edge system where the ML model is already deployed. For example, the local configuration information may include initial values for parameters of the ML model used by the source edge system such as weights, coefficients, hyperparameters, and the like, which are used to setup the ML model on the source edge system.

In 622, the method may include receiving, via a network, a notice of a cold start of a receiving edge system associated with an industrial asset. Here, the notice may include an indicator of an IP address or web location of the receiving edge system for broadcast purposes. As another example, the notice may include a request from the receiving edge system for ML model information. In 623, the method may include cloning parameters of the ML model and the local configuration of the source edge system where the ML model is deployed to generate a cloned ML model configuration. In some embodiments, the cloning may be performed in response to a cold start of the receiving edge system. In 624, the method may include transmitting the cloned ML model configuration to the receiving edge system. In some embodiments, the method may include configuring the source edge system to be a broadcast cloning system for edge systems that are started within a predetermined geographic area of the source edge system.

FIG. 6C illustrates a method 630 of incrementing an incremental ML model in accordance with an example embodiment. For example, the method 630 may be performed by a server, a cloud platform, a user device, and the like. Referring to FIG. 6C, in 631, the method may include storing an incremental ML model comprising a plurality increments which sequentially increase a complexity of a predictive function of the incremental ML model. The incremental ML model may have a plurality of versions where each sequential version increases a complexity of a prior version in the sequence. In addition, the plurality of increments may sequentially increase a prediction accuracy of the incremental ML model when processing incoming data of the industrial asset.

In 632, the method may include receiving performance information from an edge system processing incoming data of an industrial asset using a current increment of the incremental ML model. In some embodiments, the received performance information may include one or more of a predication accuracy of the current increment of the incremental ML model, an amount of time since the current increment was deployed, an amount of data received during a predetermined period of time, a number of hardware sensors that have been activated and which are providing the incoming data of the industrial asset, and the like.

In 633, the method may include dynamically determining to modify the current increment of the incremental ML model used by the edge system with a next increment of the incremental ML model having increased complexity based on the received performance information, and in 634, the method may include transmitting the next increment of the incremental ML model to the edge system. For example, the next increment may add one or more additional layers to a neural network of the incremental ML model, add an additional parameter (e.g., weight, coefficient, etc.) to the incremental ML model, and the like, with respect to the current increment. Each increment among the plurality of increments may be associated with a predetermined accuracy threshold of the incremental ML model. In some embodiments, the dynamically determining may include detecting that the current increment of the incremental ML model has achieved its respective predetermined accuracy threshold, and in response, transmitting the next increment of the incremental ML model to the edge system.

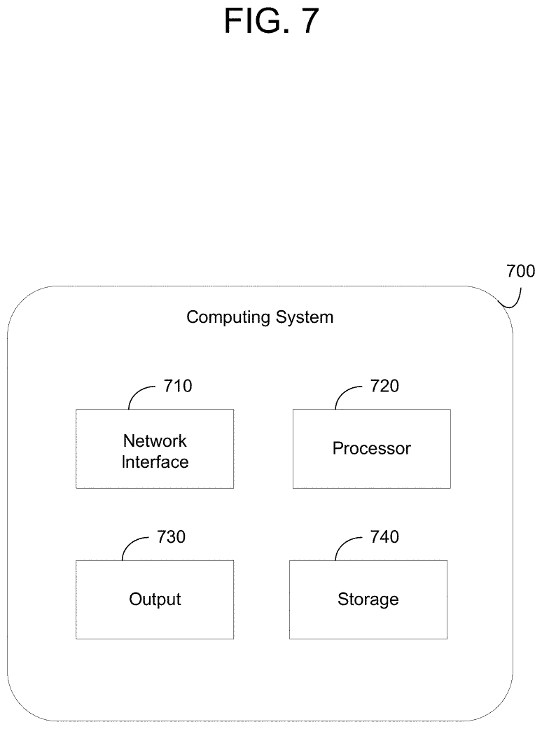

FIG. 7 illustrates a computing system 700 for use in accordance with an example embodiment. For example, the computing system 700 may be an edge computing device, a cloud platform, a server, a database, and the like. In some embodiments, the computing system 700 may be distributed across multiple devices such as both an edge computing device and a cloud platform. Also, the computing system 700 may perform any of the methods described herein. Referring to FIG. 7, the computing system 700 includes a network interface 710, a processor 720, an output 730, and a storage device 740 such as a memory. Although not shown in FIG. 7, the computing system 700 may include other components such as a display, an input unit, a receiver, a transmitter, and the like.

The network interface 710 may transmit and receive data over a network such as the Internet, a private network, a public network, and the like. The network interface 710 may be a wireless interface, a wired interface, or a combination thereof. The processor 720 may include one or more processing devices each including one or more processing cores. In some examples, the processor 720 is a multicore processor or a plurality of multicore processors. Also, the processor 720 may be fixed or it may be reconfigurable. The output 730 may output data to an embedded display of the computing system 700, an externally connected display, a display connected to the cloud, another device, and the like.

The storage device 740 is not limited to a particular storage device and may include any known memory device such as RAM, ROM, hard disk, and the like, and may or may not be included within the cloud environment. The storage 740 may store software modules or other instructions which can be executed by the processor 720 to perform the methods described herein. Also, the storage 740 may store software programs and applications which can be downloaded and installed by a user.

According to various embodiments, the storage 740 may store machine learning (ML) models and local edge information where the ML models are already deployed. In some embodiments, the network interface 710 may receive, via a network, meta information of an edge system associated with an industrial asset in response to a cold start of the edge system. In response, the processor 720 may dynamically determine an optimum ML model for the cold start of the edge system from among the already deployed ML models based on the received meta information and the local edge information. Furthermore, the processor 720 may control the network interface 710 to transmit the determined optimum ML model to the edge system.

According to various embodiments, the storage 740 may store a machine learning (ML) model and local configuration information of a source edge system where the ML model is already deployed. In this example, the network interface 710 may receive, via a network, a notice of a cold start of a receiving edge system associated with an industrial asset In response, the processor 720 may clone parameters of the ML model and the local configuration of the source edge system where the ML model is deployed to generate a cloned ML model configuration. Furthermore, the processor 720 may control the network interface 710 to transmit the cloned ML model configuration to the receiving edge system.

According to various embodiments, the storage 740 may store an incremental ML model that includes a plurality increments which sequentially increase a complexity of a predictive function of the incremental ML model. Here, the processor 720 may receive, via the network interface 710, performance information from an edge system processing incoming data of an industrial asset using a current increment of the incremental ML model. In response, the processor 720 may dynamically determine to modify the current increment of the incremental ML model used by the edge system with a next increment of the incremental ML model having increased complexity based on the received performance information. The network interface 710 may transmit the next increment of the incremental ML model to the edge system.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store an incremental ML model comprising a plurality increments which sequentially increase a complexity of a predictive function of the incremental ML model;
a processor configured to receive performance information from an edge system that processes incoming data of an industrial asset using a current increment of the incremental ML model, and dynamically determine to modify the current increment of the incremental ML model used by the edge system with a next increment of the incremental ML model having increased complexity based on the received performance information; and
a network interface configured to transmit the next increment of the incremental ML model to the edge system.

2. The computing system of claim 1, wherein the plurality of increments sequentially increase a prediction accuracy of the incremental ML model when processing incoming data of the industrial asset.

3. The computing system of claim 1, wherein the next increment adds one or more additional layers to a neural network of the incremental ML model with respect to the current increment.

4. The computing system of claim 1, wherein the received performance information comprises a predication accuracy of the current increment of the incremental ML model.

5. The computing system of claim 1, wherein the received performance information comprises one or more of an amount of time since the current increment was deployed and an amount of data received during a predetermined period of time.

6. The computing system of claim 1, wherein the received performance information comprises a number of hardware sensors that have been activated and which are providing the incoming data of the industrial asset.

7. The computing system of claim 1, wherein each increment among the plurality of increments comprises a predetermined accuracy threshold of the incremental ML model.

8. The computing system of claim 7, wherein the processor is configured to detect that the current increment of the incremental ML model has achieved its respective predetermined accuracy threshold, and in response, control the network interface to transmit the next increment of the incremental ML model to the edge system.

9. A method comprising:
storing an incremental ML model comprising a plurality increments which sequentially increase a complexity of a predictive function of the incremental ML model;
receiving performance information from an edge system that processes incoming data of an industrial asset using a current increment of the incremental ML model;
dynamically determining to modify the current increment of the incremental ML model used by the edge system with a next increment of the incremental ML model having increased complexity based on the received performance information; and
transmitting the next increment of the incremental ML model to the edge system.

10. The method of claim 9, wherein the plurality of increments sequentially increase a prediction accuracy of the incremental ML model when processing incoming data of the industrial asset.

11. The method of claim 9, wherein the next increment adds one or more additional layers to a neural network of the incremental ML model with respect to the current increment.

12. The method of claim 9, wherein the received performance information comprises a predication accuracy of the current increment of the incremental ML model.

13. The method of claim 9, wherein the received performance information comprises one or more of an amount of time since the current increment was deployed and an amount of data received during a predetermined period of time.

14. The method of claim 9, wherein the received performance information comprises a number of hardware sensors that have been activated and which are providing the incoming data of the industrial asset.

15. The method of claim 9, wherein each increment among the plurality of increments comprises a predetermined accuracy threshold of the incremental ML model.

16. The method of claim 15, wherein the dynamically determining comprises detecting that the current increment of the incremental ML model has achieved its respective predetermined accuracy threshold, and in response, transmitting the next increment of the incremental ML model to the edge system.

17. A non-transitory computer readable medium storing program instructions which when executed are configured to cause a computer to perform a method comprising:
storing an incremental ML model comprising a plurality increments which sequentially increase a complexity of a predictive function of the incremental ML model;
receiving performance information from an edge system that processes incoming data of an industrial asset using a current increment of the incremental ML model;
dynamically determining to modify the current increment of the incremental ML model used by the edge system with a next increment of the incremental ML model having increased complexity based on the received performance information; and
transmitting the next increment of the incremental ML model to the edge system.

18. The non-transitory computer readable medium of claim 17, wherein the plurality of increments sequentially increase a prediction accuracy of the incremental ML model when processing incoming data of the industrial asset.

19. The non-transitory computer readable medium of claim 17, wherein the next increment adds one or more additional layers to a neural network of the incremental ML model with respect to the current increment.

20. The non-transitory computer readable medium of claim 17, wherein the received performance information comprises a predication accuracy of the current increment of the incremental ML model.
